(19) United States
(12) Patent Application Publication
(10) Pub. No.: US 2024/0191763 A1
(43) Pub. Date: Jun. 13, 2024

(54) Seal assembly for a brake piston of a vehicle wheel brake, the seal assembly having a stiffening member

(71) Applicant: HL MANDO CORPORATION, Pyeongtaek (KR)

(72) Inventor: Hatem SHAHIN, Pfaffenhofen (DE)

(21) Appl. No.: 18/464,138

(22) Filed: Sep. 8, 2023

(30) Foreign Application Priority Data
Dec. 7, 2022 (DE) 102022213234.3

(51) Int. Cl. F16D 65/18; F16J 15/3268

(52) U.S. Cl. CPC F16D 65/18; F16J 15/3268; F16D 2125/08

(57) ABSTRACT

The invention relates to a seal assembly for a brake piston of a vehicle wheel brake,
the brake piston being displaceably received in a housing and the seal assembly being configured to fluidically seal the brake piston with respect to the housing;
the seal assembly comprising:
   an elastically deformable seal member having a first portion that is configured to contact an outer surface of the brake piston;
   a stiffening member arranged at least a second portion of the seal member.

The invention also relates to brake piston assembly comprising such a seal assembly.

### CROSS-REFERENCE TO RELATED APPLICATION

This application is based on and claims priority under 35 U.S.C. § 119 to German Patent Application No. 102022213234.3, filed on Dec. 7, 2022 in the German Patent and Trade Mark Office, the disclosures of which are incorporated herein by reference.

### TECHNICAL FIELD

The invention relates to a seal assembly for a vehicle wheel brake, in particular a vehicle disc brake. The invention also relates to a brake piston assembly such a vehicle wheel brake and comprising a seal assembly. The vehicle may in particular be a road vehicle, such as a car, a truck or a bus.

### BACKGROUND

In known vehicle wheel brakes and in particular vehicle disc brakes, brake pistons are displaceable to transmit a force onto a brake pad. The brake pad can thus be forced into contact with a member jointly rotating with the vehicle brake, such as a brake disc. This produces a brake force.

The brake piston is typically a cylindrical member having a circular cross-section. It is received in a cavity (typically formed as a hollow cylinder) in a housing. The housing is often formed by or comprised by a brake caliper.

The brake piston and the cavity jointly delimit a hydraulic chamber. Pressurised hydraulic fluid is received in or released from said hydraulic chamber to displace the brake piston for activating and deactivating the brake, respectively. A seal is provided to hydraulically seal the brake piston with respect to the cavity. The seal is elastically deformable under displacement of the brake piston. An example of an existing brake piston assembly comprising a respective seal can be found in U.S. Pat. No. 7,255,207 B2.

It is also known that such seals may have a so-called rollback-effects. This includes that after a displacement of the brake piston and a release of the hydraulic pressure, the elastic relaxation of the seal exerts a force onto the brake piston. This force may push the brake piston back into its original position which it assumed prior to brake activation.

It has been observed that the brake pedal feel of existing vehicle wheel brakes is not always stable. Also, it has been observed that a defined brake fluid volume and/or pressure within the hydraulic chamber may not always translate into an expected brake force. It is therefore an object of this invention to improve the performance of brake piston assemblies comprising seals.

### SUMMARY

This object is solved by the subject matter according to the attached independent claims. Advantageous embodiments are set out in the dependent claims and in this description.

Accordingly, a seal assembly for a brake piston of a vehicle wheel brake is disclosed, the brake piston being displaceably received in a housing and the seal assembly being configured to fluidically seal the brake piston with respect to the housing; the seal assembly comprising:
an elastically deformable seal member having a first portion that is configured to contact an outer surface of the piston;
a stiffening member arranged at at least a second portion of the seal member,

The stiffening member may generally be stiffer than the seal member. It may be made form a different and stiffer material compared to the seal member. Accordingly, the stiffening member may provide an at least local stiffening function reducing the in particular axial extent of elastic deformation of the seal member during braking.

The brake piston may be displaceable along a displacement axis. Said axis may extend in parallel to a rotational axis of a brake disc and/or a vehicle wheel that is to be braked. References to directions such as axial, radial and circumferential may generally relate to said displacement axis. An axial direction may extend along or in parallel to said displacement axis, a radial direction may extend at an angle and in particular orthogonally thereto and a circumferential direction may extend about or around said displacement axis.

According to one embodiment, the stiffening member is configured to not be elastically deformable in reaction to a displacement of the brake piston, or, put differently, is configured to remain stiff and/or elastically undeformed in reaction to a displacement of the brake piston. Accordingly, the stiffening member may e.g. not provide a spring function and/or may not be elastically deformable in a spring-like manner. Rather, the stiffening member may generally maintain its shape during braking.

According to a general realization of this disclosure, it has been determined that the elastic deformation and in particular axial compression of the seal may contribute to altering an expected volume of the hydraulic chamber. This contribution may be unintended and difficult to predict. As a result, the volume of the hydraulic chamber may, apart from its intended and predictable increase due to a displacement of the brake piston, be altered and in particular increased by the elastic deformation of the seal. This may result in an additional brake fluid volume intake during braking (i.e. to fill the additional volume of the hydraulic chamber resulting from the deformed and in particular axially compressed or deflected seal member).

Relevant cases of seal deformation that contribute to additionally increasing the hydraulic chamber volume may include an axial compression of the seal. Another relevant case, that may occur additionally or alternatively, relates to the seal being axially deflected in the displacement direction of the brake piston (i.e. typically towards a brake disc or brake pad). As a result, the seal may be deflected away from e.g. a centre of the hydraulic chamber, so that the hydraulic chamber's volume may increase accordingly.

The intake of additional brake fluid volume during braking can be one reason for the occurrence of an unexpected pedal feel. Also, it means that e.g. a defined brake fluid volume or brake pressure that e.g. according to calculations or simulation models is expected to produce a certain brake force may be insufficient to produce said brake. Rather, said volume or pressure may be partially absorbed by the additional share of volume of the hydraulic chamber resulting from the seal deformation. This may limit brake performance, e.g. in terms of effectiveness by means of which (at least initially and independently of a seal deformation) provided brake fluid volumes and brake pressures translate into generated brake forces.

The disclosed seal assembly addresses these issues by reducing the elastic deformability of the seal member. For doing so, the stiffening member is provided which acts as a stiffening structure for at least locally (e.g. at said second portion) limiting the elastic deformation of the seal member. In consequence, the seal's contribution to an additional change of volume of the hydraulic chamber may be reduced, thereby limiting a size of additional brake fluid volume intake caused by the seal deformation.

On the other hand, the first portion of the seal member that is in contact with the piston is still elastically deformable, thus providing a reliable sealing function.

Other possible advantages concern a simplified assembly due to the stiffening member being better manually operable than the flexible sealing member. Also, the stiffening member may help to at least partially equalize manufacturing tolerances between the stiffening member and the housing.

The seal assembly fluidically sealing the brake piston with respect to the housing may be equivalent to forming a fluidically sealed connection between these members. The seal assembly may be substantially stationary (e.g. apart from its deformation) with respect to the brake piston.

The seal assembly may e.g. be received in a receiving section of the housing, such as a groove and in particular a circular or ring-shaped groove. The receiving section may be provided at an inner surface or inner wall of the housing and more specifically of a cavity of the housing in which the brake piston is received. The piston and in particular an outer circumferential surface thereof may be in contact with an inner circumferential surface of the seal member. The piston may slide along and relative to said seal member. The piston may not directly contact the housing, but rather be supported by the seal assembly in the housing (and/or with respect to the housing).

The seal member may e.g. have a circular or a polygonal and in particular a rectangular cross-section. The first and second portion of the seal member may be formed by different faces (in particular differently oriented faces) of the seal member. Additionally or alternatively, they may be formed by different circumferential sections of the seal member and in particular of a cross-section of the seal member. Generally, the cross-section of the seal member may be defined in a plane that comprises a displacement axis of the brake piston.

In order to remain undeformed during brake piston displacement, a stiffness of the stiffening member may be set accordingly, e.g. by a respective material choice and/or a design and/or a dimensioning of the stiffening member. Specifically, the expected forces during brake piston displacement which act on the seal assembly may be known, so that the seal assembly can be suitably designed to provide its sealing effect. Also, the brake piston assembly for which the seal assembly is intended is typically marked by expected and admissible ranges of hydraulic pressures during braking. Therefore, the range of expected and/or of admissible forces that may act on the stiffening member may be generally known. The stiffening member may thus be designed to not be significantly elastically deformed when exposed to these forces, unlike the elastically deformable seal member.

The stiffness of any member and material discussed herein may e.g. be defined by an E modulus, a G modulus or a Poisson number. The stiffening member may have a lower material strength, a lower volume and/or a lower weight compared to the seal member. This way, the seal assembly may be rendered particularly compact.

One way of ensuring that the stiffening member remains undeformed is using a metal material or a rigid plastic material for forming said stiffening member. For example, the stiffening member may be a one-piece member and/or may comprise only said metal material or rigid plastic material. Any material of the stiffening member may be generally different from a material of the seal member. The stiffening member and any material thereof may generally be stiffer than the seal member and any material thereof.

In one example, the stiffening member is ring-shaped. To provide a particularly reliable and uniform stiffening effect, the stiffening member may be formed as a continuous ring and/or have constant cross-sectional dimensions. Additionally or alternatively, the seal member may be ring-shaped. Again, said ring be continuous and/or may have a constant cross-section section shape. The ring-shape of any of the stiffening member and seal member may extend concentrically to the displacement axis of the brake piston and/or may circumferentially extend about or around said displacement axis.

According to a further example, the stiffening member is configured to contact the housing. For example, it may contact a receiving section or a groove disclosed herein and provided in said housing for receiving the seal assembly. On the other hand, at least the second portion of the seal member at which the stiffening member is arranged may not contact the housing. Put differently, the stiffening member may shield at least said second portion form a direct contact with the housing. In still other words, the stiffening member may act as a cover that is arranged in between the housing and the second portion of the seal member, thereby e.g. preventing a direct contact between said second portion and the housing. Instead, the housing may only indirectly rest against the seal member via contacting the stiffening member.

Generally, providing the stiffening member so as to contact the housing may help to provide a defined contact of the seal assembly to the housing as well as a defined deformation behaviour of the seal member. This may be caused by the stiffening member distributing forces in a defined and predictable member and in particular onto larger and/or different portions of the seal member.

In a further embodiment, the second portion comprises at least one face (in particular an outer face or side face) of the seal member. For example, said face may be an outer face of a cross-section of said seal member. Additionally or alternatively, this face may face the housing, in particular a wall or a surface of a receiving section or groove disclosed herein. The face may be oriented so that, in a hypothetical case of the stiffening member not being provided, it would be configured to contact the housing. Providing the stiffening member at such a face may achieve the desired stiffening effect of the seal member in a particularly effective manner.

In this context, the face of the seal member at which the stiffening member is arranged may be one of: a (radially) outer circumferential face of the seal member, an inner axial face of the seal member, an outer axial face of the seal member. On the other hand, the inner circumferential face of the seal member may comprise the first portion for contacting the brake piston. This contact may be beneficial for achieving the desired sealing effect, so that the inner circumferential face may generally not covered and/or not be obstructed by the stiffening member.

The outer circumferential face may face away from the piston and/or may face towards the housing. For example, it may face a circumferential face or a bottom face of an optional receiving section and in particular of a groove provided in said housing. The outer circumferential face may define a radially outermost face of the seal member. Providing the stiffening member at said outer circumferential face may limit an elastic deformation and in particular compression of at least said outer circumferential face as well as of adjacent portions of the seal member. This helps to limit this seal member's contribution to a volumetric increase of the hydraulic chamber. Also, as detailed below when discussing the figures, providing the stiffening member at said outer circumferential face may enable the formation of a press-fit between the stiffening member and the seal member.

The inner axial face and the outer axial face may define or be comprised by different or opposite sides of the seal member, said sides in particular facing away from one another. For example, the outer axial face may face towards the brake disc or towards the brake pad on which the brake piston acts, whereas the inner axial face may face away from said brake disc or brake pad. Instead, it may face towards and/or be adjacent to and/or delimit the hydraulic chamber.

Providing the stiffening member at at least one of these axial faces may provide a particularly effective stiffening effect. This is because as a result of the axial displacement of the brake piston, particularly large forces may act onto said faces which would otherwise (i.e. without the stiffening member) cause a significant elastic deformation of the seal member. Said deformation could significantly contribute to an unexpected and undesired enlargement of the hydraulic chamber in case the stiffening member was not present.

According to another example, the stiffening member has an angled cross-section. This may enable that the stiffening member is arranged at or along at least two faces of the seal member, said faces e.g. extending at a similar angle to one another as the stiffening member. In this case, the stiffening member may e.g. have a corner shaped or L-shaped cross-section (the L-shape not necessarily being upright). In this context it may be provided that the stiffening member is arranged at one axial face and at the outer circumferential face of the seal member. This may provide a particularly effective shielding and/or covering effect of the seal member to limit an undesired deflection or compression thereof.

According to a further example, the stiffening member is secured to and in particular fixed to the seal member. This may e.g. include a mechanical fixation and/or an adhesive fixation. In case of a mechanical fixation, the stiffening member may e.g. comprise projections and/or spikes that are pushed into the seal member.

Alternatively, securing the stiffening member at the seal member may include a press fit. For example, the seal member may be received in the stiffening member. In particular, it may be force fitted under an elastic deformation (in particular a radial elastic deformation) into said stiffening member. This may increase contact forces and thus frictional forces between the seal member and the stiffening member by means of which said members are secured at one another. Securing the stiffening member to the seal member may improve reliability of the desired stiffening effect over a long operational lifetime of the seal assembly.

The invention also relates to a brake piston assembly for a vehicle wheel brake (in particular a vehicle disc brake), the brake piston assembly comprising:
a brake piston,
a housing in which the brake piston is displaceably received, and
a seal assembly according to any of the aspects disclosed herein.

According to an embodiment of the brake piston assembly, the housing comprises a ring-shaped groove (or another receiving section according to any of the aspects disclosed herein), the seal assembly being received in said ring-shaped groove.

In one example, the stiffening member has a non-uniform material strength and/or has at least one tapered (and/or widened) section that e.g. extends towards the brake piston. This may allow to produce a fluid-sealing from-fit and/or force fit between the stiffening member and the housing.

### BRIEF DESCRIPTION OF DRAWINGS

Embodiments of the invention are discussed below with respect to the attached schematic figures. Throughout the figures, same features may be marked with same reference signs.

FIG. 1 is a sectional view of a brake disc assembly comprising a brake piston assembly and a seal assembly according to a first embodiment.

FIG. 2 is a sectional view of the brake piston assembly according to the first embodiment.

FIG. 3 is a sectional view of the seal assembly according to the first embodiment.

FIG. 4 is a sectional view of the brake piston assembly according to a second embodiment.

FIG. 5 is a sectional view of the seal assembly according to the second embodiment.

FIG. 6 is a sectional view of the brake piston assembly according to a third embodiment.

FIG. 7 is a sectional view of the seal assembly according to the third embodiment.

FIG. 8 is a sectional view of the brake piston assembly according to a fourth embodiment.

FIG. 9 is a sectional view of the seal assembly according to the fourth embodiment.

FIG. 10 is a sectional view of the brake piston assembly according to a fifth embodiment.

FIG. 11 is a sectional view of the seal assembly according to the fifth embodiment.

FIG. 12 is a sectional view of the brake piston assembly according to a sixth embodiment.

FIG. 13 is a sectional view of the seal assembly according to the sixth embodiment.

### DETAILED DESCRIPTION

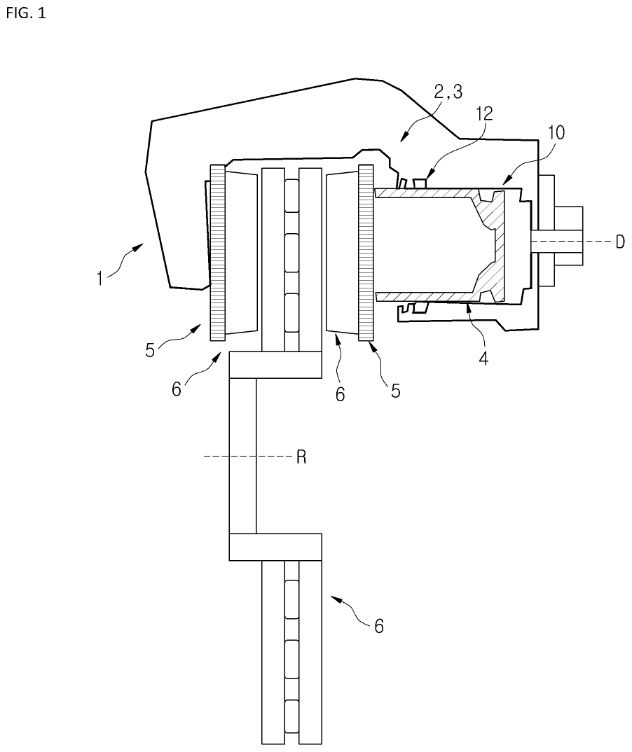

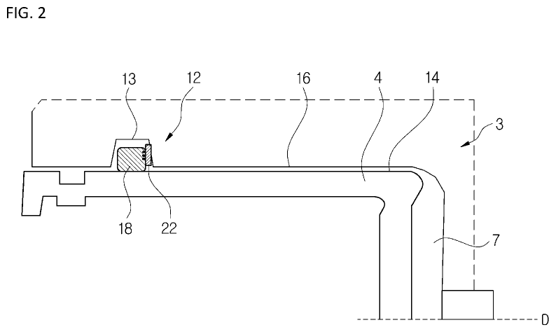

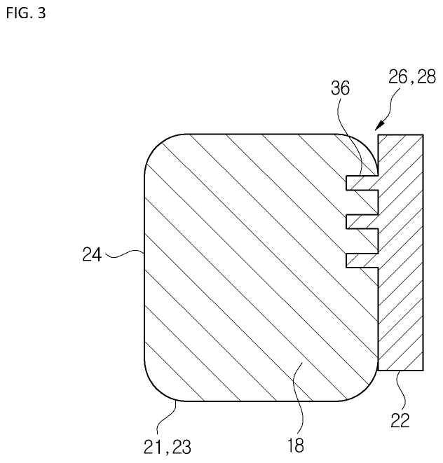

FIG. 1 is a schematic sectional view of a wheel brake assembly 1 in from of a disc brake assembly and comprising a brake piston assembly 10 and seal assembly 12 according to a first embodiment. Details of the seal assembly 12 are not visible in FIG. 1 but are discussed below with respect to FIGS. 2 and 3. Rather, FIG. 1 serves to schematically indicate a position of said seal assembly within the wheel brake assembly 1.

The wheel brake assembly 1 comprises a brake disc 8 that is coupled to a non-illustrated vehicle wheel for a joint rotation about a rotation axis R. The wheel brake assembly 1 also comprises a brake caliper 2 forming a housing 3 in which a brake piston 4 is provided. The brake piston 4 is displaceable along a displacement D. In the shown example, said displacement axis D extends in parallel to the rotation axis R.

The wheel brake assembly 1 also comprises a pair of brake pads 5 arranged on opposite sides of the brake disc 8 and each comprising a brake lining 6 made of a friction material. The brake piston 4 is configured to contact one of the brake pads 5 and thus to exert a force thereon for pressing the brake pad 5 into contact with the brake disc 8. According to known floating caliper principles, the other brake pad 5 may thus be forced into contact with the respectively adjacent surface of the brake disc 8 as well.

The brake piston 4 is received in a cylindrical cavity of the housing 3. The walls of said cavity and the outer surface of the brake piston 4 delimit a hydraulic chamber 7 in which a pressurised brake fluid is receivable. In order to produce a braking effect, the brake fluid volume and thus pressure within said hydraulic chamber 7 is increased, thereby pushing the brake pad 4 in the left direction of FIG. 1. In order to deactivate the brake, the pressure is at least partially released. The seal assembly 12 provides a hydraulically sealed connection between the brake piston 4 and the housing 3, so that no hydraulic volume may leak out of the hydraulic chamber 8 across and/or past said seal assembly 12.

FIG. 2 is a detail view of the brake piston assembly 10 of FIG. 1. Specifically, the upper halves of the brake piston 4 and of the seal assembly 12 are shown. Only a part of the housing 3 is visible. For illustrative purposes only, a dashed outline is depicted in FIG. 2 (and in some of the subsequent figures) which does not correspond to actual physical limits of the housing 3. The piston 4 is a cylindrical member that, as an option, is hollow and has a circular cross-section. Its outer circumferential surface 14 defines a mantle surface or cylinder jacket. It faces a correspondingly shaped (i.e. cylindrical) inner surface 16 of the hydraulic chamber 7 and is positioned at a slight radial distance thereto. Instead of contacting the inner surface 16 of the hydraulic chamber 7, the piston 4 and more precisely its outer circumferential surface 14 contacts the seal assembly 12.

Said seal assembly 12 is received in a receiving section formed as a groove 13, said groove 13 extending concentrically about the displacement axis D.

The seal assembly 12 comprises a ring-shaped seal member 18 and a ring-shaped stiffening member 22. The seal member 18 comprises a radially inner circumferential face 23 (see FIG. 3 discussed below) facing away from the receiving section 13 and generally being exposed so as to be contacted by the brake piston 4. This contact provides a fluidically sealed connection between the seal assembly 12 and brake piston 4 as well as the housing 3. The inner circumferential face 23 defines a first portion 21 of the seal member 18.

The seal member 18 comprises or is completely made of an elastic material, such as a synthetic rubber material. It is thus configured to be elastically deformable under the forces that are exerted thereon during a regular brake operation. This may in particular relate to compression forces resulting from the seal member 18 being forced against at least one adjacent surface of the receiving section 13. For example, due to frictional forces between the brake piston 4 and the seal member 18, the latter may be drawn in the direction of displacement of the brake piston 4, thus forcing the seal member 18 against an inner surface of the receiving section 13.

As a result, the seal member 18 may be axially compressed and/or may generally be deflected. This may result in a degree by which the receiving section 13 is filled by the seal member 18 being reduced (or, put differently, a share of the volume of said receiving section 13 that is occupied by the seal member 18 being reduced) at least in an axial direction. Additionally or alternatively, a share of a free volume of the receiving section 13 (i.e. free of the seal member 18) that is fluidically connected to the remainder of the hydraulic chamber 7 may increase as a result of the elastic deformation of the seal member 18. Simulations have shown that this may increase the total volume of the hydraulic chamber 7 by several percent. As a result, an additional brake fluid volume may flow into the hydraulic chamber 7 which is accompanied by the above discussed disadvantages.

To limit the extent of said additional brake fluid volume intake, the stiffening member 22 is provided at a second portion 24 of the seal member 18, see FIG. 3. Said FIG. 3 is an enlarged view of the portion of the seal assembly 12 that is visible in FIG. 2. This second portion 24 is different from the first portion 21 of the seal member 18.

In the first embodiment, the stiffening member 22 is a plate-shaped ring member (e.g. formed as a ring washer). It is arranged at an inner axial face 26 of the seal member 18. The inner axial face may be adjacent to and/or delimit the hydraulic chamber 7 in contrast to an opposite outer axial face 28 of the seal member 18.

As an optional feature, the stiffening member 22 is secured to the seal member 18 by means of spikes 36 that penetrate the seal member 18.

Coming back to FIG. 2, it can be seen that the seal member 18 can optionally be received in the receiving section 13 with some axial and/or radial play of e.g. not more than 1 mm. When the piston 4 is displaced to the left for activating the brake, the seal member 18 is forced into contact with the (in FIG. 2) left axial end face of the receiving section 13. This results in axial compression forces acting on the seal member 18. However, due to one of the axial faces 26 of the seal member 18 being stiffened by the stiffening member 22, a resulting axial deformation of the seal member 18 may be limited and the compressive forces may be largely compensated for by a radial expansion of the seal member 18. This limits an axial shortening and thus axial increase of the hydraulic chamber 7, thereby limiting the additional brake fluid volume intake discussed above.

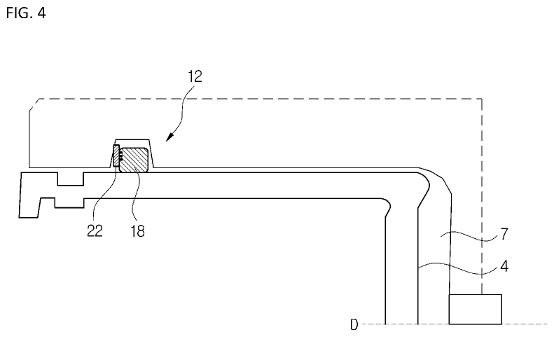

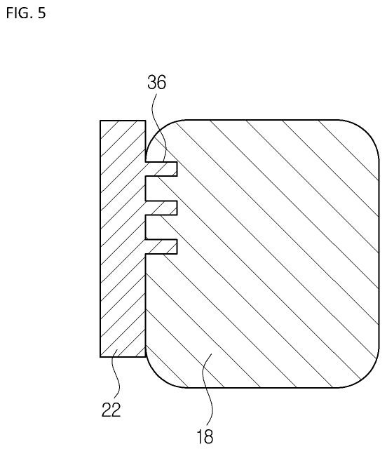

FIGS. 4 and 5 are views similar to FIGS. 2 and 3. They show another embodiment that is similar to the embodiment of FIG. 2 apart from the position of the stiffening member 22. More precisely, in the second embodiment of FIGS. 4 and 5, the stiffening member 22 is arranged at the outer axial face 28 of the seal member 18. Again, this may limit the axial compression of the seal member 18 when displacing the brake piston 4, the seal member 18 e.g. instead being radially deformed to a larger degree. The stiffening member 22 again optionally has spikes 36 protruding axially towards and into the seal member 18.

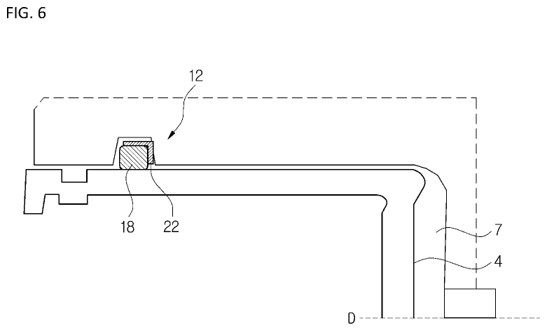

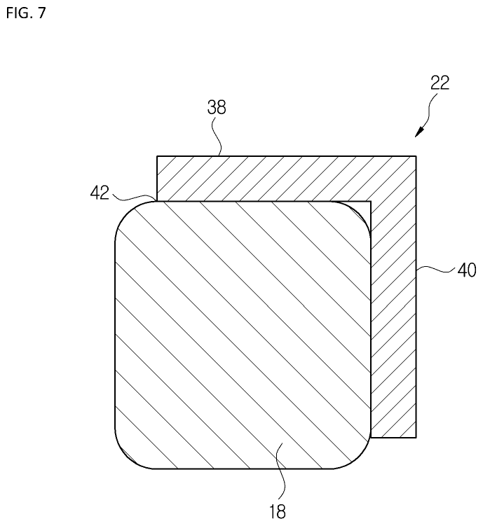

FIGS. 6 and 7 are views similar to FIGS. 2 and 3 and FIGS. 4 and 5. They show another embodiment that, apart from the shape of the stiffening member 22, is similar to that of these previous figures. In more detail, in the embodiment of FIGS. 6 and 7, the stiffening member 22 has an angled shape. In these depicted cross-sectional views, the stiffening member 22 has an axially extending portion 38 and a radially extending portion 40 that merge with one another. The axially extending portion 38 contacts an outer circumferential face 42 of the seal member 18. A diameter of said axially extending portion 38 may be smaller than a diameter of said outer circumferential face 42 when the seal member 18 is undefined. Thus, the depicted assembled state of the seal assembly 12 may include the seal member 18 being force fitted into the stiffening member 22 in order to secure said members 18, 22 to one another.

By means of the axially extending portion 38, a stiffening effect of the stiffening member 22 is increased compared to the previous embodiments. For example, due to the now obstructed radial expansion when experiencing axially compressive forces, the seal member 18 may be even stronger axially pushed towards the right in FIG. 6, which helps limiting a volume increase of the hydraulic chamber 7.

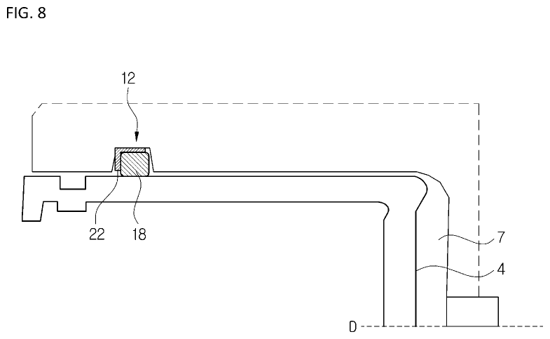

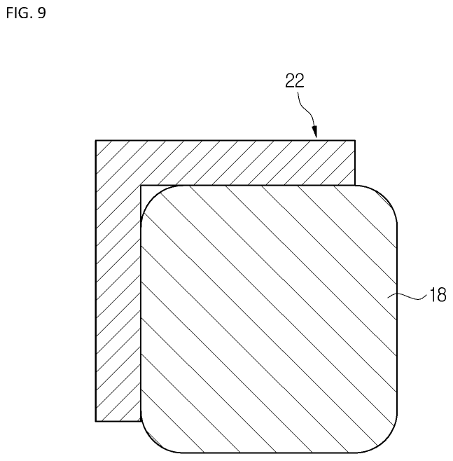

FIGS. 8 and 9 are views similar to FIGS. 6 and 7 and showing an embodiment that is similar said Figures. The only difference is the cross-sectional shape of the stiffening member 22 which is mirrored compared to FIGS. 6 and 7.

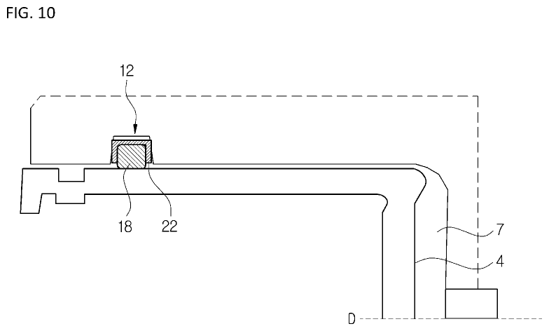

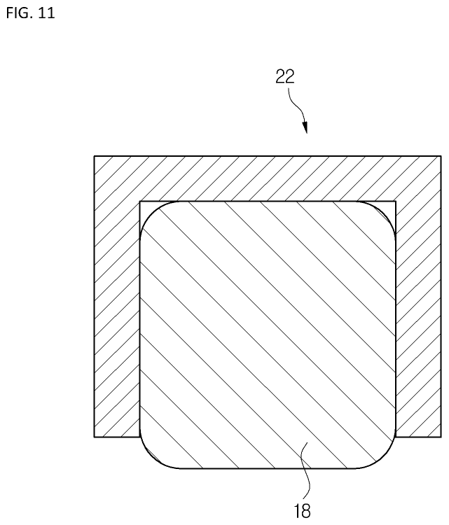

FIGS. 10 and 11 are views similar to FIGS. 2 and 3 and FIGS. 4 and 5. In this case, the stiffening member 22 has a C-shaped cross-section with the open side of the C-shape facing inwards, i.e. the C-shape not being upright. Accordingly, only the inner circumferential face 23 of the seal member 18 is exposed to contact a respectively adjacent surface (in this case of the brake piston 4). The remaining faces of the seal member 18 (i.e. its inner and outer axial faces 26, 28 and the outer circumferential face 42) are covered by the stiffening member 22. In this case, possible axial contact forces which act on the seal assembly 12 may be substantially fully absorbed by stiffening member 22. As a result, in particular the axial dimensions of the seal assembly 12 may be substantially constant. Thus, an additional increase in the volume of the hydraulic chamber 7 that could be otherwise (i.e. without the stiffening member 22) be caused by an elastic deformation of the seal member 18 can be substantially eliminated.

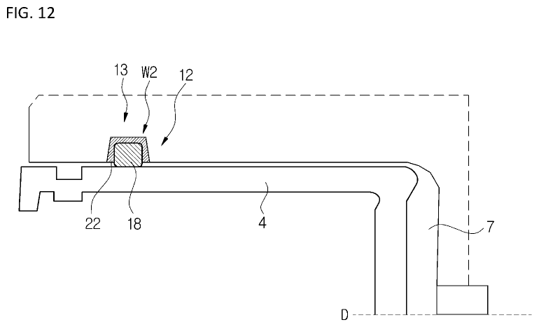

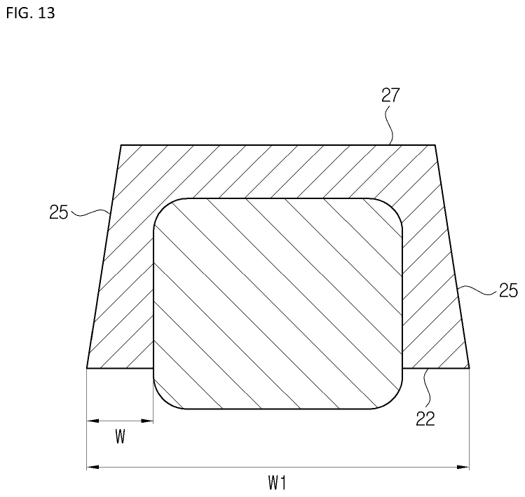

FIGS. 12 and 13 are views similar to FIGS. 2 and 3, FIGS. 4 and 5 and FIGS. 10 and 11. In this case, the stiffening member 22 has a non-uniform material strength to produce a liquid-sealing contact between the stiffening member 22 and the receiving section 13.

In the shown example, the stiffening member 22 has two radial sections 25 extending from a (radially outer) closed bottom section 27 of the stiffening member 22 towards the brake piston 4. The seal member 12 is received in space surrounded by the radial sections 25 closed bottom section 27. A radial inner end of said radial sections 25 which faces the brake piston 4 has a maximum width W (e.g. compared to a radial outer end of said radial sections). Said width W is measured along the displacement axis D and corresponds to a material strength of the stiffening member 22. As evident from FIG. 13, said width W increases (e.g. linearly) from the closed bottom section 27 towards the brake piston 4.

This increasing width W results in a total width W1 (at least at the radial inner portion) of the stiffening member 22 exceeding a respective width W2 of the receiving section 13. Accordingly, the stiffening member 22 can only be inserted into the receiving section 13 under an elastic deformation, this producing a fluid-sealing contact between the stiffening member 22 and the receiving section 13. Similar to the previous embodiment, a liquid-sealing contact is also provided between the seal member 18 and the brake piston 4. Therefore, liquid cannot flow across the seal assembly 12 and out of the hydraulic chamber 7.

It is noted that the above-discussed elastic deformation of the stiffening member 22 is merely optional. The stiffening member 22 may also be sufficiently rigid to prevent a respective deformation during assembly and operation. In this case, the tapered and widened radial sections 25 as well as the widths W, W1, W2 may be selected to support the formation of a tight and in particular fluid-sealing form fit between the stiffening member 22 and the receiving section 13.

What is claimed is:

1. A seal assembly for a brake piston of a vehicle wheel brake,
the brake piston being displaceably received in a housing and the seal assembly being configured to fluidically seal the brake piston with respect to the housing;
the seal assembly comprising:
an elastically deformable seal member having a first portion that is configured to contact an outer surface of the brake piston;
a stiffening member arranged at at least a second portion of the seal member.

2. The seal assembly according to claim 1,
wherein the stiffening member is configured to remain undeformed in reaction to a displacement of the brake piston.

3. The seal assembly according to claim 1,
wherein the stiffening member comprises a metal material or a rigid plastic material.

4. The seal assembly according to claim 1,
wherein the stiffening member and/or the seal member are ring-shaped.

5. The seal assembly according to claim 1,
wherein the stiffening member is configured to contact the housing.

6. The seal assembly according to claim 1,
wherein the second portion comprises at least one face of the seal member,
wherein the face is one of: an outer circumferential face, an inner axial face, an outer axial face.

7. The seal assembly according to claim 6,
wherein the stiffening member has an angled cross-section so as to be arranged at at least two different faces of the seal member.

8. The seal assembly according claim 1,
wherein the stiffening member is secured at the seal member.

9. Brake piston assembly for a vehicle wheel brake,
the brake piston assembly comprising:
a brake piston,
a housing in which the brake piston is displaceably received, and
a seal assembly according to claim 1.

10. Brake piston assembly according to claim 9,
wherein the housing comprises a ring-shaped groove, the seal assembly being received in said ring-shaped groove.
